(19) United States
(12) Patent Application Publication
(10) Pub. No.: US 2026/0094105 A1
(43) Pub. Date: Apr. 2, 2026

(54) System and Method for Standardizing and Displaying Environmental Impact Data of Building Materials Using Life-Cycle Assessment Data and Machine Learning

(71) Applicant: Joshua Alexander Schultz, Los Angeles, CA (US)

(72) Inventor: Joshua Alexander Schultz, Los Angeles, CA (US)

(21) Appl. No.: 19/334,960

(22) Filed: Sep. 22, 2025

Related U.S. Application Data
(60) Provisional application No. 63/700,746, filed on Sep. 29, 2024.

(51) Int. Cl. G06Q 10/0639

(52) U.S. Cl. CPC G06Q 10/06393

(57) ABSTRACT

The present invention relates to a system and method for calculating, standardizing, and displaying environmental impact data of construction materials. The system reconciles data discrepancies from various life-cycle assessment (LCA) sources using advanced machine learning algorithms and statistical models. It applies regulatory thresholds and presents data through an intuitive environmental label in the form of Percent Daily Values (PDV) for key environmental categories, including global warming potential and energy consumption. The system dynamically adjusts to updated regulatory standards, providing accurate, consumer-friendly environmental labels for experts and non-experts.

### FIELD OF THE INVENTION

This invention relates to environmental data processing and display systems, specifically a method and system for calculating, standardizing, and displaying the environmental impact of building materials using life-cycle assessment (LCA) data. The system harmonizes discrepancies across multiple sources of environmental data and generates standardized environmental labels, such as Percent Daily Value (PDV), aligned with regulatory benchmarks, like those provided by the U.S. Environmental Protection Agency (EPA).

### PRIOR ART

In the field of environmental impact data processing, several systems have been proposed for managing and analyzing life-cycle assessment (LCA) data. However, none combine the features of multi-source data reconciliation, regulatory benchmarking, and consumer-friendly labeling as effectively as this system. Below are notable references:
U.S. Pat. No. 9,210,923—Environmental Impact Assessment System: This system describes a method for assessing environmental impacts but does not reconcile data discrepancies from multiple sources, nor does it generate standardized consumer-facing labels using Percent Daily Values (PDV).
U.S. Pat. No. 10,584,200—Life-Cycle Analysis Database Management: This patent provides a system for managing LCA data but lacks the ability to normalize and reconcile conflicting data from different methodologies, making it less reliable for cross-source analysis.
U.S. Pat. No. 8,856,373—Method for Visualizing Environmental Data: This patent proposes a system for visualizing environmental data but focuses primarily on graphical representation and does not offer real-time updates based on regulatory changes or use PDV-like consumer labeling.

In contrast, the present invention solves the above limitations by offering a system that integrates data from multiple sources, applies statistical reconciliation methods, and dynamically adjusts environmental labels based on local regulatory standards. Furthermore, the system's consumer-friendly PDV format distinguishes it from prior art, making it more accessible to non-expert users.

### BACKGROUND OF THE INVENTION

The need for environmental impact data standardization for building materials is growing, particularly in light of global climate initiatives. Currently, environmental impact data across life-cycle assessments (LCA) varies widely in terms of methodology and scope, leading to discrepancies in measurements for global warming potential (GWP) and other key metrics. This inconsistency makes it difficult for consumers, builders, and regulatory bodies to accurately assess the sustainability of building materials.

This invention addresses these challenges by providing a system that aggregates data from multiple sources, reconciles discrepancies, and generates a standardized environmental label using the Percent Daily Value (PDV) approach. The invention applies regulatory thresholds (such as those from the EPA), making the environmental data easy to interpret for both experts and non-experts.

### SUMMARY OF THE INVENTION

The present invention provides a comprehensive system and method for retrieving life-cycle assessment (LCA) data from multiple sources, reconciling inconsistencies, and generating standardized environmental labels for building materials. These labels are customized to display Percent Daily Values (PDV) for key environmental categories, such as GWP, acidification potential (AP), and energy consumption, in alignment with regulatory benchmarks (e.g., EPA's guidelines for low-carbon materials).

### Key Features of the Invention

Data Processing Module: This module retrieves LCA data from various sources and formats, including databases like EcoInvent, OpenLCA, and other proprietary sources.

Data Reconciliation Module: This module applies weighted mean and variance models to normalize and reconcile environmental data discrepancies, prioritizing reliable datasets.

Calculation Module: Converts normalized environmental impact data into Percent Daily Values by comparing material impacts to regulatory thresholds.

Presentation Module: This module generates standardized environmental labels for key impact categories (e.g., GWP, AP), customized for local regulatory standards, such as those set by the EPA.

### BRIEF DESCRIPTION OF DRAWINGS

FIG. 1: Illustrates the system's high-level structure, showing interactions between modules like Product Category Rules (PCR), Data Sources, Materials, and Emissions, and how they contribute to environmental data processing and reconciliation.

FIG. 2: Shows the technical architecture of the database, illustrating relationships between LCA Data, Reconciled Data, Environmental Labels, and User Queries, emphasizing the system's data processing capabilities.

FIG. 3: Demonstrates the system's ability to generate material labels in the PDV format, focusing on how reconciled data is presented to consumers in a user-friendly manner.

FIG. 4: Highlights the end-to-end data flow from ingestion to the final presentation of standardized labels.

FIG. 5: Shows a flowchart of the machine learning process, focusing on how data is ingested, historical data is used for weight adjustments, and the system improves data reconciliation over time.

### DETAILED DESCRIPTION OF THE INVENTION

### Data Processing Module

The Data Processing Module is responsible for retrieving environmental impact data from multiple life-cycle assessment (LCA) sources. These sources may include public databases like EcoInvent, OpenLCA, and manufacturers' Environmental Product Declarations (EPDs). The system is designed to handle varying data formats (e.g., XML, JSON, CSV), which are normalized into a unified format suitable for processing.

The module also includes validation checks to ensure the integrity of incoming data. Data errors, missing values, and inconsistencies are flagged for further processing by the Data Reconciliation Module.

### 2. Data Reconciliation Module

This module addresses the challenge of inconsistent environmental data from varying sources and methodologies. A weighted mean and variance model is used to prioritize more reliable data sources (e.g., full cradle-to-gate data). By applying these weights, the system minimizes the influence of less reliable or incomplete datasets.

The Data Reconciliation Module uses machine learning to automatically reconcile environmental data from various sources. The system continuously learns from new data inputs, adjusting the weights assigned to datasets based on their reliability and completeness. For example, a dataset that consistently provides complete life-cycle data is prioritized over less complete data sources. Over time, the machine learning algorithms refine these adjustments, ensuring the most accurate reconciliation possible as new data becomes available. Over time, the system adjusts the weighting of datasets based on their reliability and completeness. The system uses supervised learning models to continuously analyze discrepancies between datasets, prioritizing data sources that have historically produced accurate and complete environmental impact data. For example, the system might assign a higher weight to a dataset that consistently provides cradle-to-gate data, which includes the entire life cycle of a building material. As more data is processed, the machine learning algorithms refine the model to ensure the most accurate reconciliation of environmental data. These algorithms adjust the weighting of datasets based on historical performance, source reliability, and the completeness of the data.

### 3. Calculation Module

This module converts the reconciled data into Percent Daily Values (PDV) by comparing the environmental impact of a material to regulatory thresholds (e.g., EPA's Low Embodied Carbon Label Program). Each environmental impact category (e.g., GWP, EP) is processed individually, allowing a granular comparison against benchmarks.

For instance, consider a building material with an annual carbon emissions value of 1,485.96 kg CO₂e per metric ton of CO₂, which includes Global Warming Potential (GWP) and other impact categories converted to CO₂ from their respective units, as detailed in Table 1. Given the EPA threshold of 2.5×10⁷ kg CO₂e per year, the system would calculate the Percent Daily Value (PDV) and Percent Yearly Value (PYV) as follows:

$$PYV ( GHGRP ) = ( 1 , 485.96 kg {CO}_{2} e / 25 , 000 ) \times 100 = 5.94 \%$$

$$Daily GHGRP Threshold = 25 , 00 \; 0 / 365 = 68.49 metric tons {CO}_{2} e / day$$

$$PDV ( GHGRP ) = ( 1.485 \text{.96} kg / 68.49 ) \times 100 \approx 2.17 \%$$

### GHGRP Threshold:

PYV (Percent Yearly Value): 5.94% of the 25,000 metric ton/year GHGRP threshold.
PDV (Percent Daily Value): 2.17% of the 68.49 metric ton/day GHGRP threshold.

This simple calculation makes it easier for non-experts to quickly assess a material's environmental footprint. The product (per metric ton) uses 5.94% of the GHGRP's yearly emissions threshold and 2.17% of the daily threshold, which is moderate.

### 4. Presentation Module

The Presentation Module generates standardized environmental labels using the calculated PDV values for each key environmental category. These labels can be customized to align with local regulatory guidelines, such as EPA standards or EU regulations. The labels are exportable in various formats, including PDF, web, and mobile formats, ensuring flexibility in usage.

In addition, the system dynamically updates labels based on new regulatory standards. For example, if the EPA revises its thresholds, the system automatically updates the labels to reflect the new standards, ensuring that users always have access to up-to-date information.

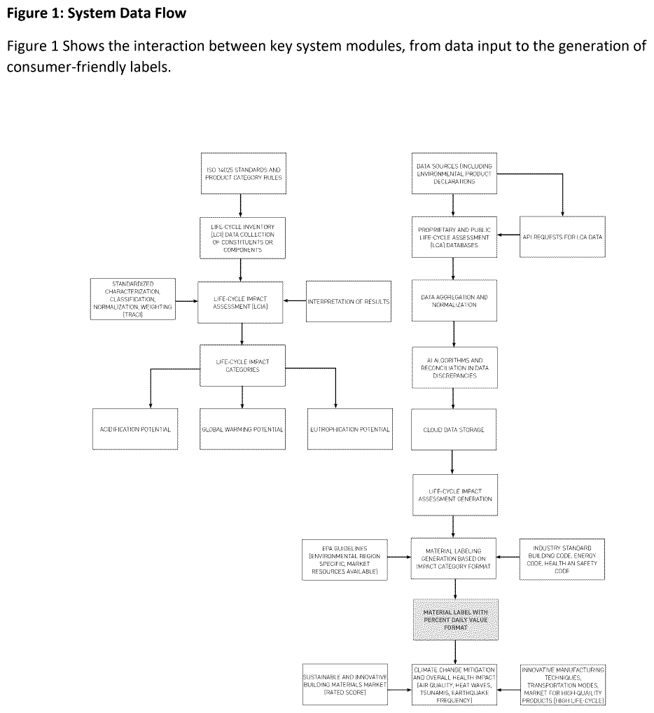

### FIG. 1: System Data Flow

FIG. 1 presents a high-level overview of the system, illustrating how LCA data is ingested, standardized, validated, and reconciled before being used to compute Percent Daily Values (PDV) based on regulatory thresholds. It also shows how the Presentation Module generates visual environmental labels that reflect key impact categories like GWP and AP.

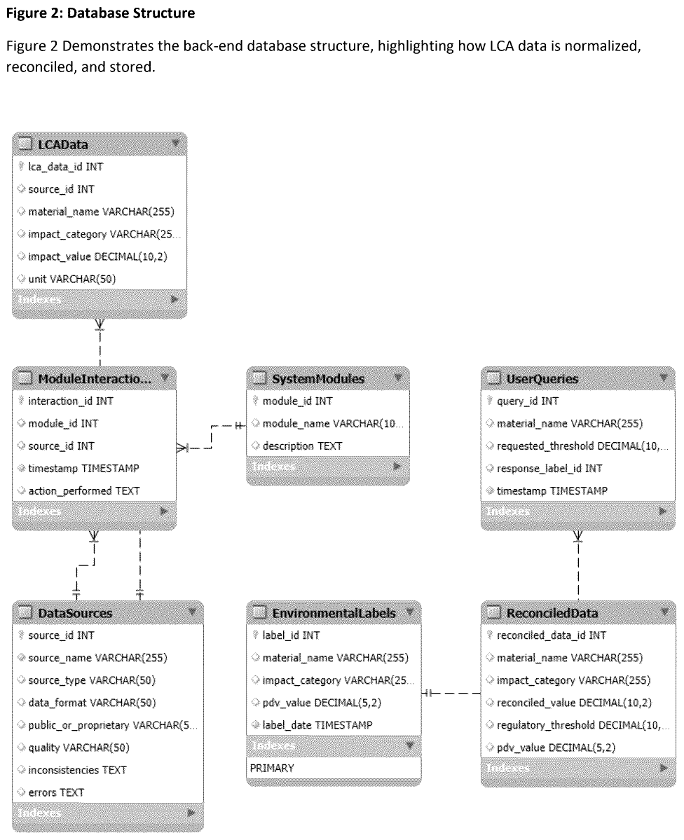

### FIG. 2: Database Structure

FIG. 2 demonstrates the system's database structure, showing relationships between key entities such as LCA Data, Reconciled Data, Environmental Labels, and User Queries. The figure highlights a normalized data model that supports data reconciliation and label generation.

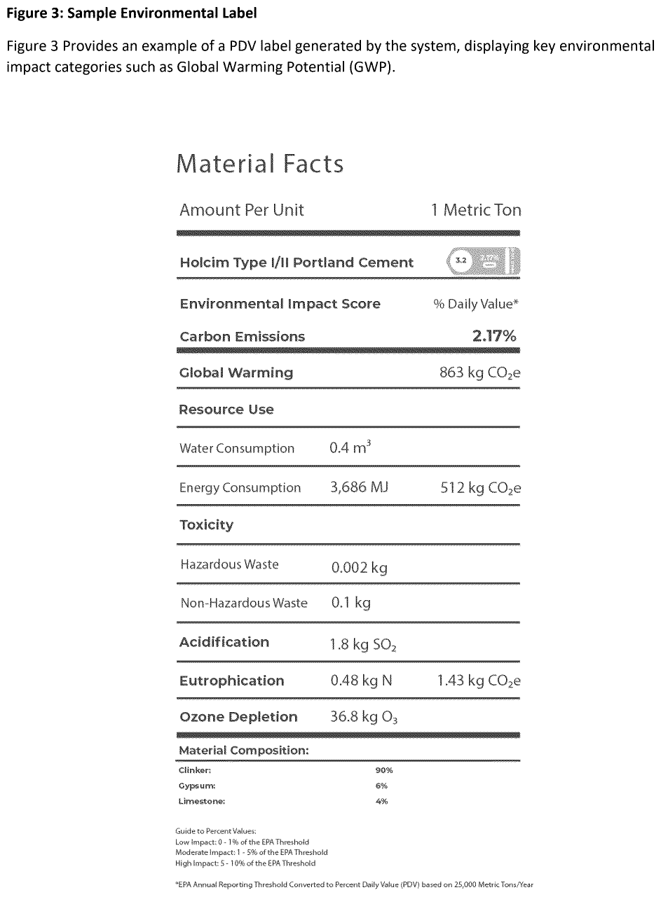

### FIG. 3: Sample Environmental Label

FIG. 3 illustrates a sample environmental label generated in the PDV format. It displays key impact categories such as Global Warming Potential (GWP) and Acidification Potential (AP), emphasizing the system's ability to create consumer-friendly labels in compliance with regulatory standards.

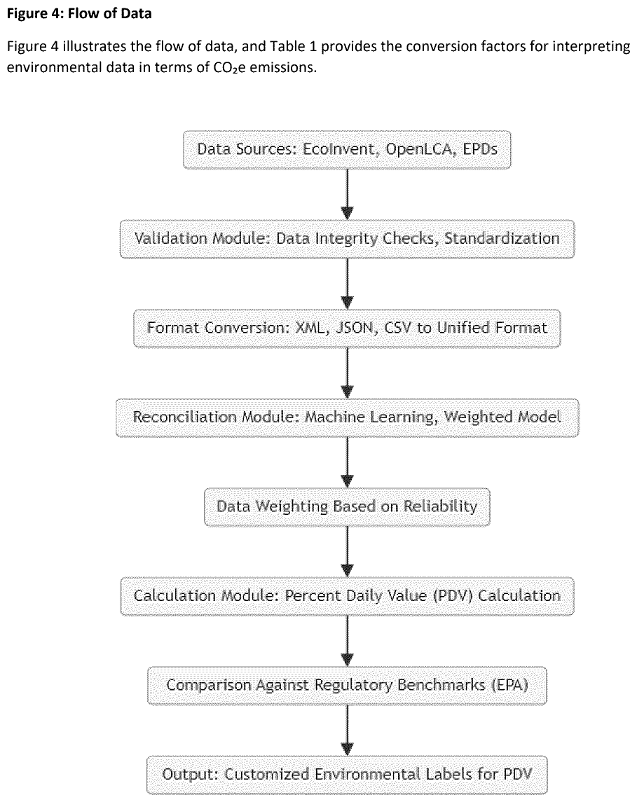

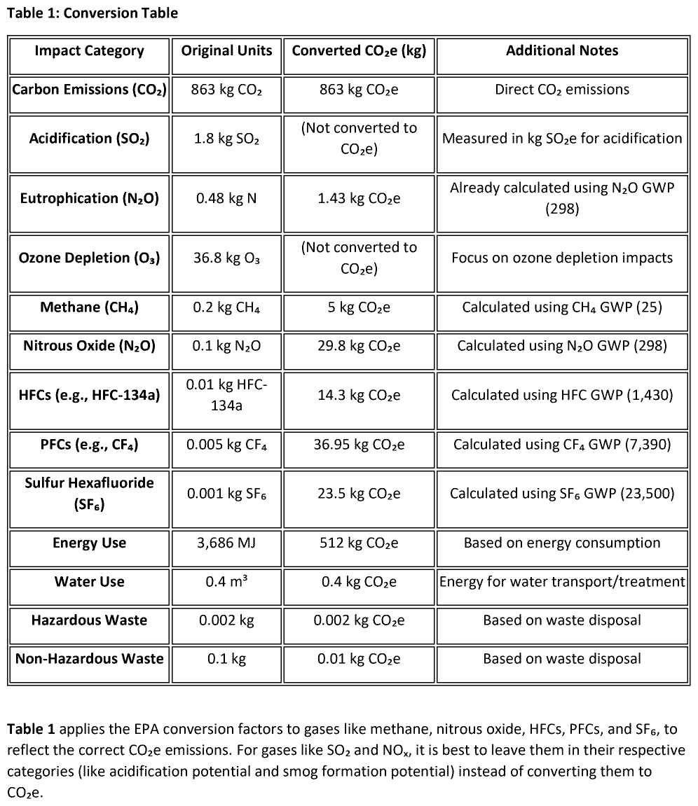

### FIG. 4: Data Flow Through the System

FIG. 4 outlines the flow of data from input through reconciliation, calculation, and presentation. The diagram highlights real-time data processing and reconciliation using machine learning algorithms, with results displayed in PDV format for easy interpretation by users.

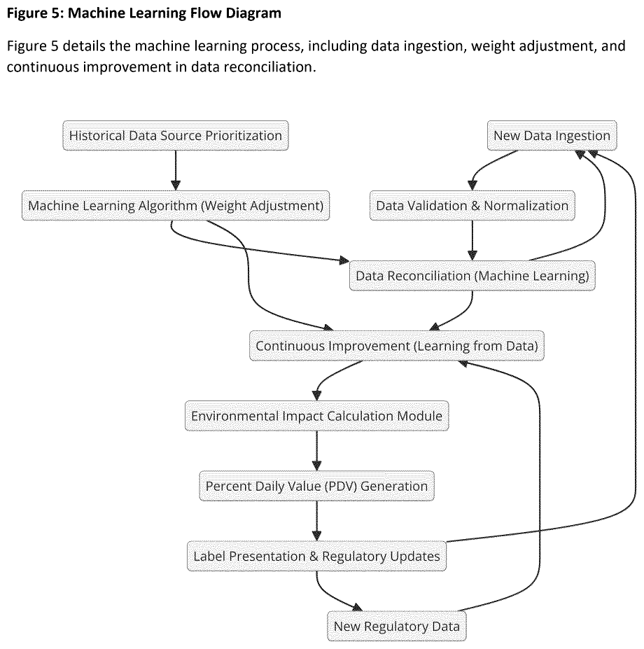

### FIG. 5: Machine Learning Flow Diagram

FIG. 5 provides a detailed flowchart of the machine learning process. It illustrates how the system ingests new data, adjusts weights based on historical performance, and continually refines its data reconciliation and prediction accuracy.

1. A system for calculating and displaying environmental impact data of building materials comprising a Data Processing Module configured to retrieve life-cycle assessment (LCA) data from multiple sources, normalize it, and perform integrity validation checks; a Data Reconciliation Module configured to normalize and reconcile discrepancies in environmental data using advanced statistical models, including weighted means, variance analysis, and machine learning-based accuracy optimization, prioritizing complete cradle-to-gate datasets; a Calculation Module configured to convert reconciled data into Percent Daily Values (PDV) and other standardized metrics by comparing material impacts against dynamic regulatory thresholds; and a Presentation Module configured to generate standardized environmental labels that display PDV for key environmental categories, dynamically customized to meet local regulatory standards including but not limited to U.S. EPA guidelines, with real-time updates based on changes to those standards, where the system is further configured to incorporate future regulatory standards automatically.

2. The system of claim 1, wherein the Data Reconciliation Module applies machine learning techniques to improve the weighting of datasets based on historical accuracy and reliability.

3. The system of claim 1 further comprises an API that allows third-party systems to query environmental data and generate custom labels based on user-defined thresholds.

4. The system of claim 1, wherein the system processes additional environmental impact categories such as water use, air quality, and toxic emissions.

5. The system of claim 1, wherein the Presentation Module is configured to update environmental labels in real-time based on changes in local regulatory standards or thresholds.

6. The system of claim 1, wherein the Data Processing Module is further configured to handle diverse data formats (XML, JSON, CSV) and includes error-checking mechanisms to validate data integrity during input processing.

7. The system of claim 1, wherein the Calculation Module provides a comparison mechanism that adjusts PDV calculations based on updated thresholds, new impact categories, or regional modifications to regulatory guidelines.

8. The system of claim 1 further comprises an audit log for tracking data source changes, calculation adjustments, and system updates to ensure the transparency and reproducibility of environmental impact assessments.
